(19) United States
(12) Patent Application Publication
(10) Pub. No.: US 2006/0207163 A1
(43) Pub. Date: Sep. 21, 2006

(54) Feeding stimulants for pest control

(76) Inventor: Ronald J Frokopy, Boston, MA (US)

Correspondence Address: FISH & RICHARDSON PC, P.O. BOX 1022, MINNEAPOLIS, MN, 55440-1022, US

(21) Appl. No.: 10/545,482

(22) PCT Filed: Feb. 13, 2004
(86) PCT No.: PCT/US04/04322

§ 371 Date: Apr. 18, 2006

Related U.S. Application Data
(60) Provisional application No. 60/447,822, filed on Feb. 13, 2003.

(51) Int. Cl. A01M 1/20

(52) U.S. Cl. 43/131

(57) ABSTRACT

A feeding stimulant release system includes a porous matrix with a feeding stimulant and a sustained-release agent. The porous matrix has at least one reservoir.

### CROSS-REFERENCE TO RELATED APPLICATION

This application claims priority from U.S. Provisional Application Ser. No. 60/447,822, filed on Feb. 13, 2003, which is incorporated herein by reference in its entirety.

### STATEMENT AS TO FEDERALLY SPONSORED RESEARCH

The work described herein was carried out, at least in part, using funds from federal grant OGCA #97A0779 (Massachusetts Society for Promoting Agriculture), OGCA #101-1331 (USDA Pest Management Alternatives Program), and OGCA #101-0805 (US EPA IR-4 Program). The U.S. Government therefore has certain rights in the invention.

### TECHNICAL FIELD

This invention relates to feeding stimulants, and more particularly to feeding stimulants used for pest control.

### BACKGROUND

Pests, such as apple maggot flies (AMF), can effect significant damage on commercial fruit production. Devices to attract and kill such pests are well known. However, a concern related to such devices is their environmental impact.

One such device uses an odor-baited sticky red sphere to attract and capture pests (e.g., apple maggot flies). However, the sticky material used to snare alighting flies is difficult to handle and requires frequent maintenance.

Thus, pesticide-treated spheres (PTS) were developed as a substitute for the above sticky-coated spheres. A PTS is coated with a mixture of insecticide, fly-feeding stimulant, and residue-extending agent. In concept, pests land on a PTS, receive a toxic dose of insecticide, and die. However, consistent lethality to pests can be assured only if the pests are strongly induced to feed upon the sphere surface and ingest a very small (but lethal) dose of insecticide. Thus, PTS must maintain a detectable residue of feeding stimulant (such as sucrose) associated with toxicant on the sphere surface. A major challenge facing the users of such spheres has been how to continuously supply the sphere surface with enough sugar to stimulate fly feeding, thereby allowing PTS to achieve maximum toxicity to pests with a minimal dose of insecticide.

Two methods have been used in an attempt to solve this problem. One method employs a reusable wooden PTS with an external source of feeding stimulant. The other method uses a disposable sugar/flour PTS whose entire body consists of sugar and starches.

Different external sources of feeding stimulant can be used with the wooden PTS. One such external source is a sucrose-bearing top-cap affixed to each PTS which, during rainfall, releases a small amount of sucrose onto the sphere surface. That is, ambient moisture causes surface sucrose to leach off of the cap and drip down onto the PTS. Thus, as surface sugar on the PTS dissipated under rainfall or heavy dew, it was replaced with sucrose from a source atop the PTS.

Originally, the caps were made almost entirely of sucrose. However, since those compositions tended to break down too easily, a paraffin/sucrose combination replaced the original sucrose caps. Thereafter, flutes were added into the tops of the caps to promote the even distribution of sucrose-bearing runoff from the surface of these caps.

### SUMMARY

The invention is based on the discovery that if you create a cap as a porous matrix with at least one reservoir, and use that cap to supply a fruit or nut mimic with pest-feeding stimulant, then you can create a pest control system that utilizes, rather than avoids, environmental moisture, such as rain, humidity, and dew, to provide long-lasting pest control.

In one aspect, the invention features a feeding stimulant release system that includes a porous matrix. The porous matrix includes a water-soluble or water-dispersible feeding stimulant, an insoluble sustained-release agent, and at least one reservoir located on an upper surface of the porous matrix. The feeding stimulant and the release agent comprise two homogenous phases dispersed in each other.

These and other embodiments may have one or more of the following advantages. The porous matrix exhibits enhanced efficiency in distribution of feeding stimulant. The porous matrix saves the user time spent on monitoring the feeding stimulant content on the surface of the fruit or nut mimic. The porous matrix is a relatively inexpensive and easily replaceable component of a pest control system. The porous matrix also increases the success rate of the fruit or nut mimic, in terms of killing target pests. The porous matrix can use a relatively small amount of toxicant to achieve a relatively high pest mortality rate, and is relatively robust. For example, the porous matrix retains its shape over relatively long periods of outdoor use.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

The details of one or more embodiments of the invention are set forth in the accompanying drawings and the description below. Other features and advantages of the invention will be apparent from the following detailed description and drawings, and from the claims.

### DESCRIPTION OF DRAWINGS

FIG. 1 is a perspective view of an embodiment of a pest control system.

FIG. 2 is a cutaway view of an embodiment of a feeding stimulant matrix.

FIG. 3 is a side view of an embodiment of a feeding stimulant matrix.

FIG. 4 is an exploded view of an embodiment of a feeding stimulant matrix.

FIG. 5 is a top view of an embodiment of a feeding stimulant matrix.

FIG. 6A is a perspective view of a second embodiment of a pest control system.

FIG. 6B is a side cross-sectional view of the pest control system of FIG. 6A.

FIG. 7A is a perspective view of an embodiment of a pest control system.

FIG. 7B is a side cross-sectional view of the pest control system of FIG. 7A.

FIG. 7C is an exploded view of the pest control system of FIGS. 7A and 7B.

FIG. 7D is a side cross-sectional view of a porous matrix from the pest control system of FIGS. 7A-7C.

FIG. 8A is a side view of an embodiment of a pest control system.

FIG. 8B is a side cross-sectional view of the pest control system of FIG. 8A.

Like reference symbols in the various drawings indicate like elements.

### DETAILED DESCRIPTION

The invention is based on the discovery that if you create a cap as a porous matrix with at least one reservoir, and use that cap to distribute toxicant to pests and/or to supply a fruit or nut mimic with pest-feeding stimulant, then you can create a pest control system with long-lasting effects. The porous matrix includes a feeding stimulant and a sustained-release agent. In some embodiments, the porous matrix further includes one or more toxicants. The fruit or nut mimic includes a mixture of feeding stimulant and residue-extending agent. In some embodiments, the fruit or nut mimic can include one or more toxicants (that can be different from, or the same as, the toxicant(s) in the porous matrix). If the porous matrix is suspended above the fruit or nut mimic, for example, ambient moisture collected in the reservoirs can leach through the porous matrix, causing feeding stimulant to drip from the porous matrix onto the fruit or nut mimic. Consequently, the fruit or nut mimic is continually refreshed with feeding stimulant for many weeks to months, e.g., for the entire growing season. In some embodiments, the porous matrix can form a portion of the fruit or nut mimic (can be integral with the fruit or nut mimic shape). The porous matrix can include a toxicant and a feeding stimulant that, along with the shape and color of the fruit or nut mimic, attracts pests. The pests can feed on the porous matrix and/or on the fruit or nut mimic, thereby ingesting toxicant.

Structure

Pest Control System

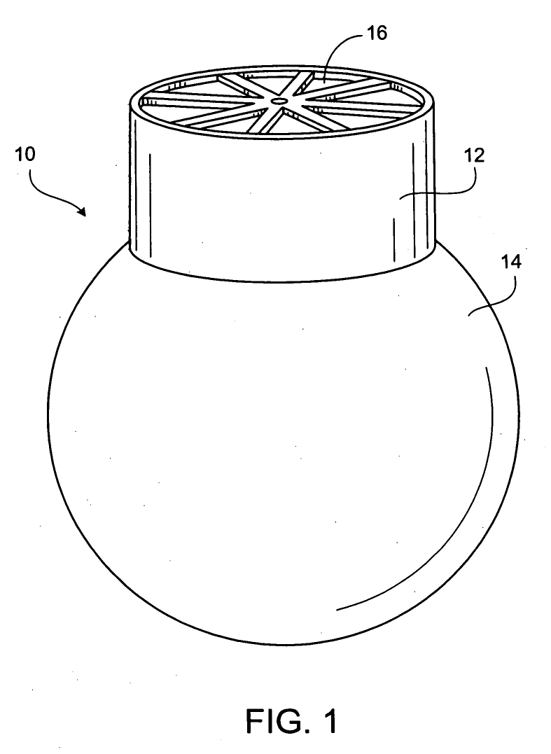

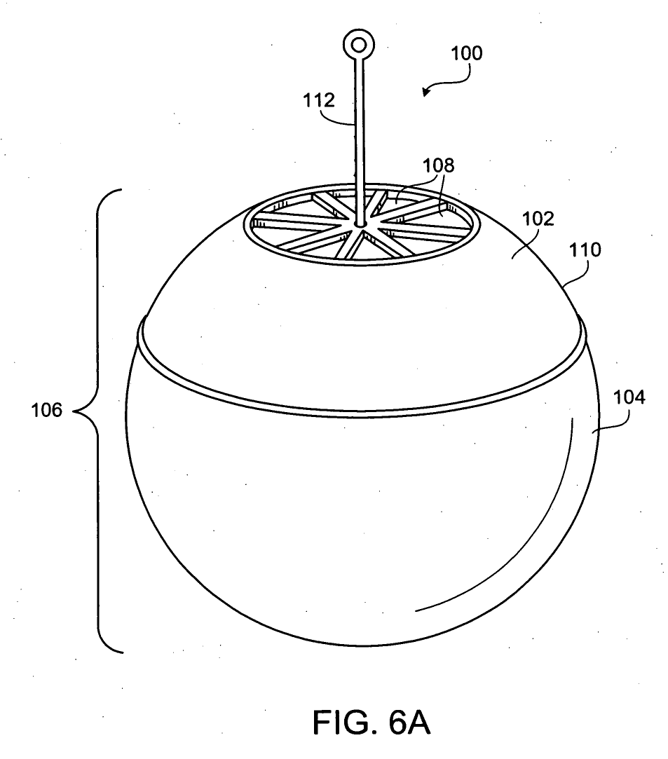

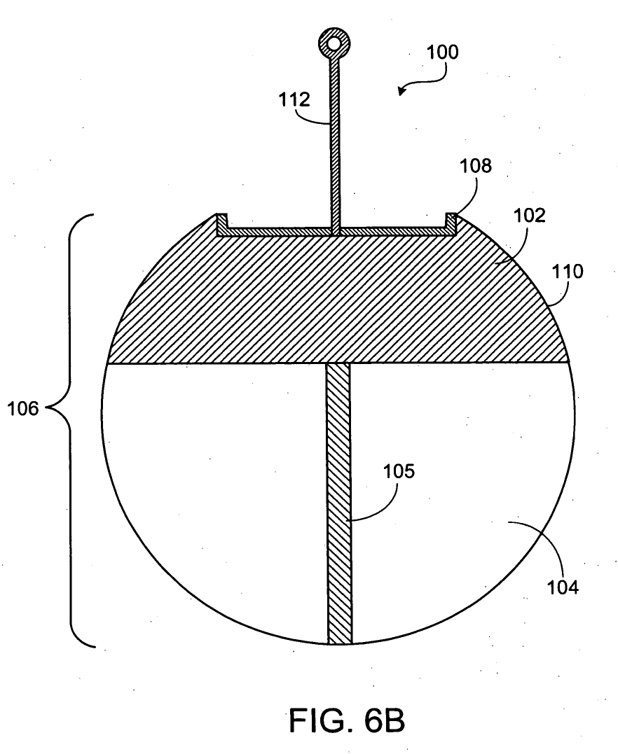

FIGS. 1 and 6A show pest control systems 10, 100 that include a porous matrix 12, 102 with one or more reservoirs 16, 108 and a fruit or nut mimic 14, 106.

Fruit or Nut Mimic

The fruit or nut mimic 14 is a wooden or plastic structure, e.g., a sphere. Fruit or nut mimic 14 can have a coating that contains a mixture of a toxicant such as an insecticide (e.g., imidacloprid, thiacloprid, spinosad, avermectin, thiamethoxam, indoxacarb, phloxine dye, dimethoate, azinphosmethyl, diazinon, malathion, permethrin, methomyl), and/or feeding stimulant (e.g., sucrose, fructose, glucose, molasses, corn syrup, maltodextrins, corn flour, gluten), and/or residue-extending agent (e.g., latex paint). For example, fruit or nut mimic 14 can have a coating that includes a residue-extending agent, without including a toxicant or a feeding stimulant. The residue-extending agent can enhance the long-term efficacy of toxicant on the fruit or nut mimic by, for example, protecting the toxicant from exposure to rainfall.

The shape and color of a fruit or nut mimic depends on the relevant fruit or nut to be protected from pests. For example, a blueberry mimic is a comparatively large red or green sphere, with a diameter of about 9 cm. Apple mimics are spheres with a diameter of about 9 cm, colored red or black to capitalize on the visual spectrum maximally attractive to apple maggot flies. The shape of mimics applicable to tropical fruit and citrus species depends on the protected crop and targeted pest, but commonly used shapes include spheres (with a diameter of about 6-10 cm) and rectangles. Mimic traps used in the monitoring and protection of walnuts are dark green spheres with a diameter of about 9 cm.

Targeted pests include any pests which can be attracted to feed, forage, or lay eggs on the attached mimic by visual or chemical stimuli and can be controlled by the toxicants used in the device or the attached devices (e.g., apple maggot flies, blueberry fruit flies, Caribbean fruit flies, Mediterranean fruit flies, oriental fruit flies, olive fruit flies, walnut husk flies, house flies, cherry fruit flies, melon fruit flies, Mexican fruit flies, beetles, moths, wasps, and cockroaches).

Porous Matrix

The porous matrix 12 is made of a combination of a feeding stimulant (e.g., sucrose, fructose, glucose, molasses, corn syrup, maltodextrins, corn flour, gluten) and a sustained-release agent (e.g., paraffin wax, carnauba wax, beeswax, Japan wax, montan wax, ceresin wax). The feeding stimulant forms approximately 65-90%, e.g., 75-85%, of the porous matrix, while the sustained-release agent forms about 10-35%, e.g., 15-25%, of the matrix. The sustained-release agent may be 100% paraffin wax, for example. In some embodiments, the sustained-release agent is a combination of paraffin and carnauba wax, the ratio of paraffin to carnauba wax being between about 0.5:1.0 and 4.0:1.0, e.g., between about 1.0:1.0 and 3.0:1.0. An advantage to using a combination of carnauba wax and paraffin wax as the sustained-release agent is that the porous matrix may exhibit better resistance to heat degradation relative to a porous matrix made only of paraffin wax, since carnauba wax has a higher melting point than paraffin wax. The porosity of the sustained-release agent depends on the amount of sustained-release agent used and on the density at which the porous matrix is formed.

The porous matrix may be a disk or “cap,” i.e., it may be in the shape of a compressed cylinder. In some cases, the side of the porous matrix that is closest to the fruit or nut mimic is carved or concave to form a tighter fit with the fruit or nut mimic. For example, if the fruit or nut mimic is spherical, then one side of the porous matrix (i.e., the “bottom side”) may be somewhat concave to better fit the sphere. In some cases, the top side and/or the bottom side of the porous matrix is planar. The porous matrix has a mass of between about 25 and 200 grams, e.g., between about 75 and 150 grams. The mass of the porous matrix will depend to some extent on the targeted pest, and the size of the mimic.

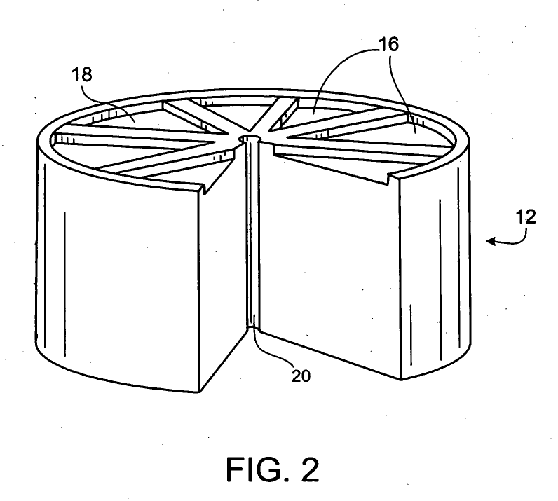

As FIG. 2 shows, porous matrix 12 has one or more reservoirs 16, for rain water, dew, and condensation, on its top side 18, i.e., the side that faces away from the fruit or nut mimic 14 when the porous matrix is suspended over the fruit or nut mimic. Because of the reservoirs and the porosity of the matrix, water can run both over the surface of and through the porous matrix, thereby coming into contact with a greater amount of feeding stimulant than it would if it just ran over the surface of the matrix. The reservoirs 16 are relatively shallow. The porous matrix has a diameter of, for example, between about 3 and 10 cm, e.g., between about 5.5 and 8 cm, and a depth of between about 2.0 and 7.0 cm, e.g., between about 2.5 and 5.5 cm. The reservoir or reservoirs, on the other hand, have a depth of between about 0.25 and 6 mm, e.g., between about 0.75 and 4.5 mm. These dimensions can be altered to fit the specific mimic and pest.

The porous matrix 12 can further define a cylindrical bore 20 through its center region. The cylindrical bore 20 is suitable for attaching a hanging apparatus to the porous matrix when the porous matrix is part of a pest control system as described above and is, for example, suspended from a tree. If present, bore 20 can also be used to connect porous matrix 12 to mimic 14.

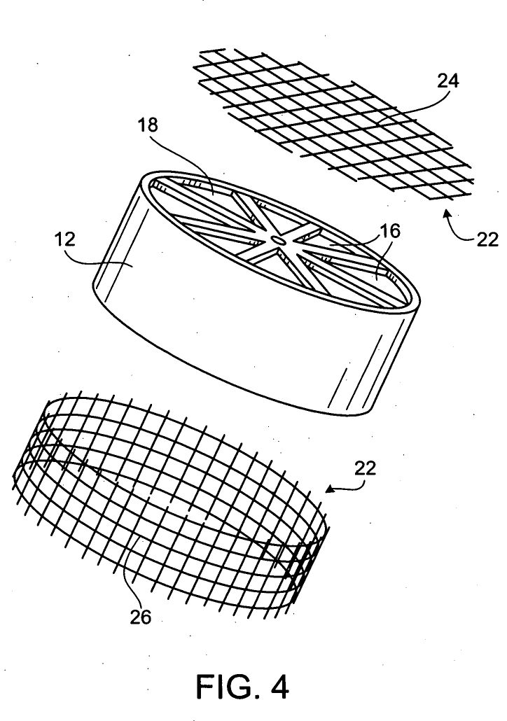

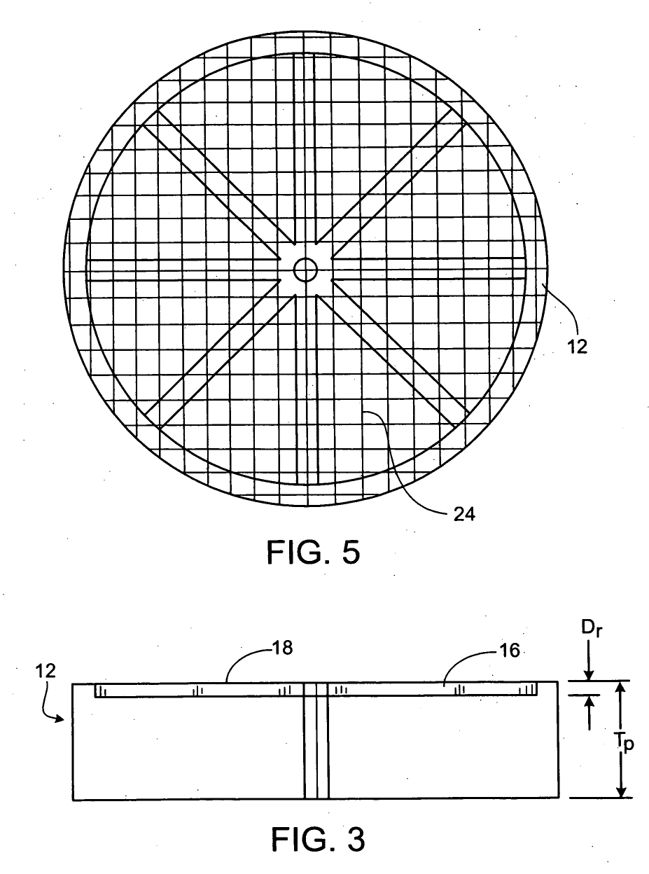

FIG. 3 shows how the reservoirs 16, which have a depth Dᵣ, are not particularly deep, relative to the thickness Tₚ of the porous matrix 12. The reservoirs gather ambient moisture, such as rain, dew, and other condensed water from the air. The water then leaches through the porous matrix or over the sides of the porous matrix, eventually streaming onto the fruit or nut mimic at an even, steady rate (e.g., drop by drop).

FIG. 2 shows one embodiment of a porous matrix 12, the embodiment having pie-shaped reservoirs. For example, the porous matrix can have between four and twelve, e.g., between six and ten, reservoirs. These reservoirs can be created by standard techniques, e.g., by stamping, pressing, cutting, or scraping the top of the matrix, or can be molded when the matrix is created. Alternatively, the reservoirs can be created by placing a rim, e.g., of plastic or metal, onto the top of the matrix to create one or more-reservoirs. For example, this rim can be in the shape of a wheel and spokes.

Dye in the Porous Matrix

The porous matrix may include a dye, e.g., a water-soluble, vegetable-based dye, that will leach out of the porous matrix over the duration of use of the matrix. For example, the dye could be a green dye, in the case of a porous matrix used atop a blueberry mimic. As ambient moisture streams through the porous matrix over time, the dye gradually leaches out of the matrix, so that the matrix fades and eventually loses its color entirely, e.g., turning white. Such a loss of color can be used to indicate to the user that the porous matrix is no longer active.

Toxicant in Porous Matrix

In some cases, the porous matrix 12 may include a toxicant. In such cases, both the porous matrix and the fruit or nut mimic may include a toxicant. The toxicant in the porous matrix maybe the same as that in the fruit or nut mimic, so that the porous matrix refreshes the mimic's toxicant content, in addition to its feeding stimulant content. Alternatively, the toxicant in the porous matrix may be different from the toxicant in the fruit or nut mimic. In some cases, the porous matrix may include a toxicant, while the fruit or nut mimic does not contain a toxicant. Examples of toxicants include insecticides, such as imidacloprid, thiacloprid, spinosad, avermectin, thiamethoxam, indoxacarb, phloxine dye, dimethoate, azinphosmethyl, diazinon, malathion, permethrin, and methomyl.

Mesh Guard on Porous Matrix

FIGS. 4-5 show how in some cases, porous matrix 12 includes a mesh guard 22 that surrounds the porous matrix. The mesh guard includes a top portion 24 and a side portion 26. The mesh guard 22 can be made of metal or plastic, for example. The mesh guard may be made out of ⅛″ grid wire, for example. The mesh guard can protect the porous matrix from being attacked and/or eaten by animals other than the targeted pests. For example, the mesh guard can prevent the porous matrix from being destroyed by rodents when the target pest is apple maggot flies.

### Other Embodiments of the Pest Control System

The new pest control systems can include a fruit or nut mimic that is partially formed of a porous matrix. Referring to FIGS. 6A and 6B, a pest control system 100 includes a porous matrix 102 that is attached to a hollow bottom hemispherical portion 104 (e.g., formed of plastic or wood). Hemispherical portion 104 includes a central rod 105 that helps the hemispherical portion to keep its shape (e.g., prevents the hemispherical portion from collapsing). In FIGS. 6A and 6B, porous matrix 102 and bottom portion 104 together form a generally spherical fruit or nut mimic 106, but other shapes are possible. Reservoirs 108 in the top of porous matrix 102 can help to collect ambient moisture and distribute it throughout porous matrix 102. Porous matrix 102 can include one or more toxicants (e.g., spinosad, available from Dow AgroSciences under the trade name Entrust 80WP®). As moisture is distributed throughout porous matrix 102, the moisture causes toxicant and/or feeding stimulant within porous matrix 102 to come to the surface 110 of the porous matrix and/or to drip onto bottom portion 104. A hanger 112 that is attached to porous matrix 102 can be used, for example, to hang pest control system 100 from a tree. Pests that are attracted to pest control system 100 can feed on either or both of porous matrix 102 and hemispherical portion 104.

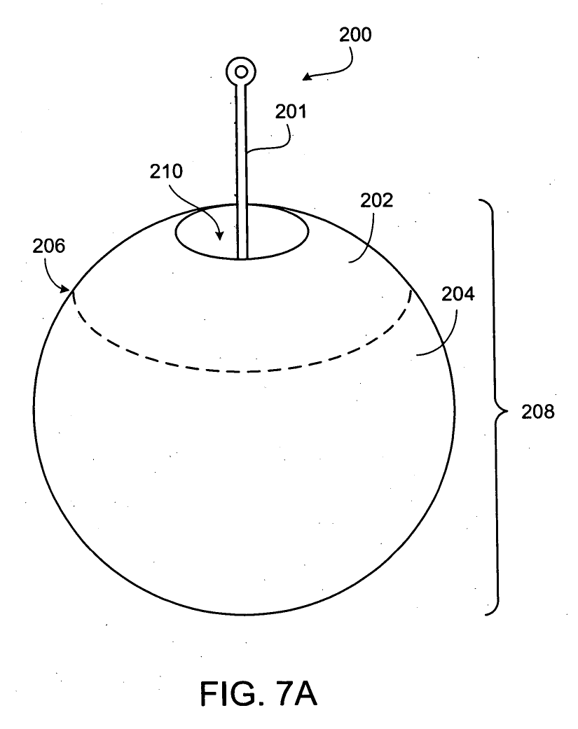

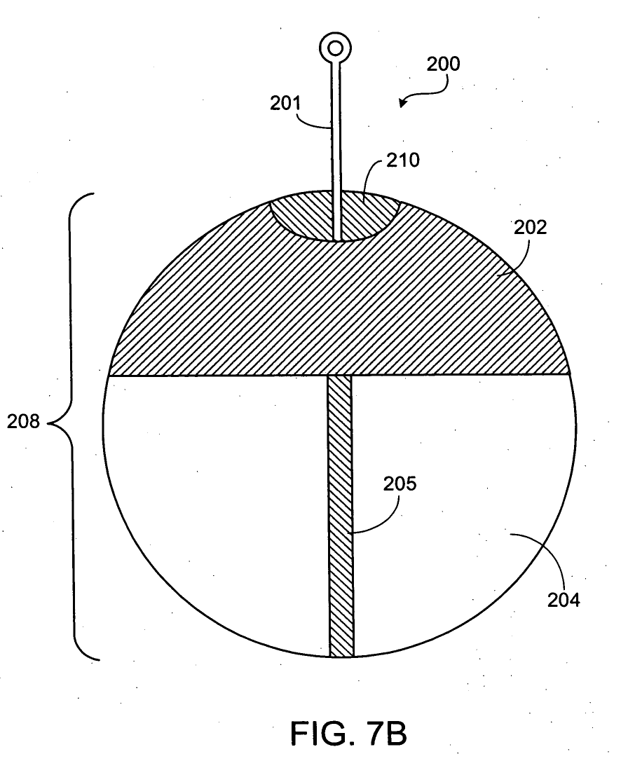

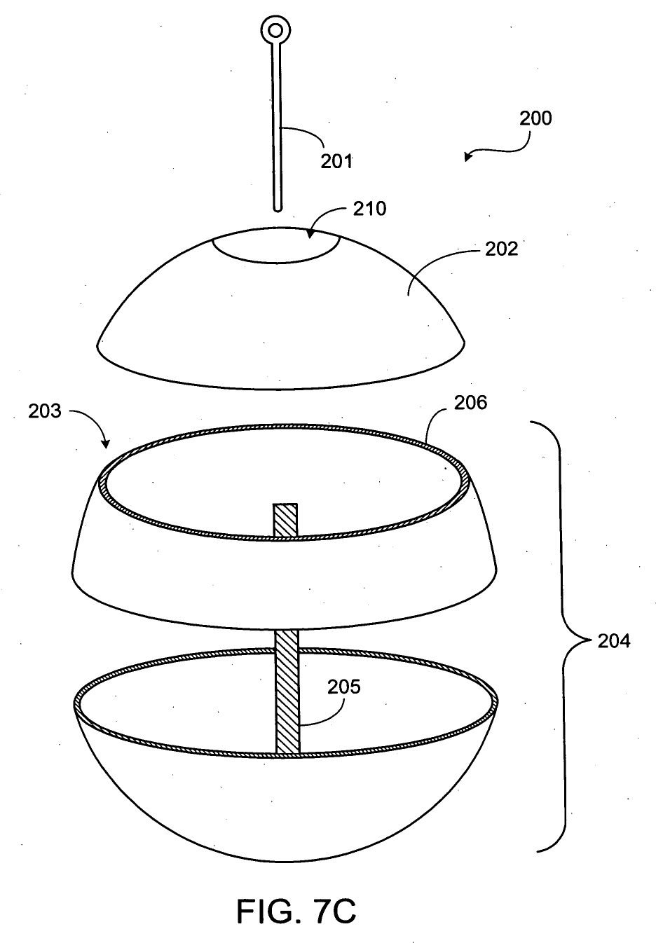

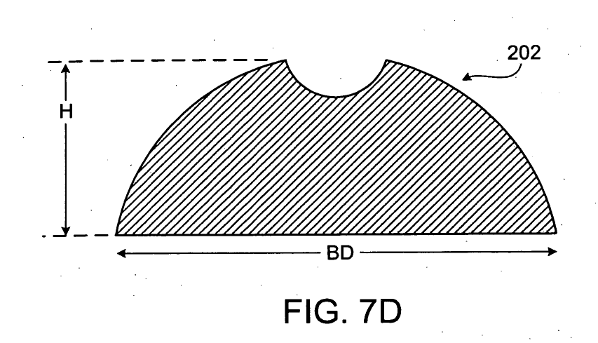

In certain embodiments, a pest control system can include one reservoir, and/or one or more reservoirs that have a non-triangular shape. Referring to FIGS. 7A-7D, a pest control system 200 includes a hanger 201, a porous matrix 202, and a hollow bottom hemispherical portion 204. Hemispherical portion 204 includes a central rod 205 that helps the hemispherical portion to keep its shape (e.g., prevents the hemispherical portion from collapsing). As FIG. 7C shows, porous matrix 202 is attached to the top portion 203 of hemispherical portion 204. Porous matrix 202 and hemispherical portion 204, which are attached at a boundary 206 (shown in FIGS. 7A (in phantom) and in FIG. 7C), form a generally spherical fruit or nut mimic 208. As shown in FIG. 7D, porous matrix 202 has a hemispherical shape with a base diameter “BD” of from about 5.0 cm to about 9.0 cm (e.g., about 7.5 cm, about 8.0 cm), and a height “H” of from about 1.0 cm to about 4.5 cm (e.g., about 2.0 cm, about 2.5 cm). Porous matrix 202 includes one or more toxicants, in addition to a feeding stimulant and a sustained release agent. While the porous matrices shown above include multiple reservoirs, porous matrix 202 has one reservoir 210, which has a concave shape. Reservoir 210 can hold from about 0.1 mL to about 5 mL of water (e.g., about 1 mL of water). Ambient moisture can collect in reservoir 210, and can flow through porous matrix 202, distributing toxicant and/or feeding stimulant to the surface of the porous matrix. Pests that are attracted to pest control system 200 can feed on either or both of porous matrix 202 and hemispherical portion 204.

Porous matrix 102 and/or porous matrix 202 can include components in one or more of the following amounts. In some embodiments, a porous matrix can include from about 0.01 weight percent to about 5.0 weight percent (e.g., about 0.10 weight percent) toxicant. A porous matrix can include from about 40.0 weight percent to about 90.0 weight percent (e.g., 79.625 weight percent) feeding stimulant (e.g., sugar). A porous matrix can include from about 0.05 weight percent to about 2.00 weight percent (e.g., about 0.25 weight percent) food coloring agent (e.g., red or green food coloring agent). In some embodiments, a porous matrix can include up to about 40.0 weight percent (e.g., about 9.75 weight percent) paraffin wax and/or carnauba wax. A porous matrix can include from about 0.05 weight percent to about 2.00 weight percent (e.g., about 0.50 weight percent) candlemaker's dye.

Porous matrix 102 and/or porous matrix 202 can have a mass of from about 60 grams to about 250 grams (e.g., about 87 grams), and/or a volume of from about 45 cm³ to about 190 cm³ (e.g., about 68 cm³), and/or a density of from about 1.00 g/cm³ to about 1.5 g/cm³ (e.g., about 1.28 g/cm³).

The feeding stimulant in porous matrix 102 and/or porous matrix 202 can be dyed (e.g., with a food coloring agent). Alternatively or additionally, the sustained release agent in porous matrix 102 and/or porous matrix 202 can be dyed (e.g., with a color that matches the food coloring agent in the feeding stimulant). In some embodiments, the sustained release agent can be dyed using candlemaker's dye.

Hemispherical portions 104 and 204 can be formed of, for example, plastic, wood, and/or metal. The hemispherical portions and porous matrices 102 and 202 can be dyed to match, so that the overall fruit or nut mimic is of a consistent color. In some embodiments, hemispherical portions 104 and 204 can have coating (e.g., a coating that includes a red paint (e.g., latex paint), and/or that includes a toxicant that is the same as, or different from, a toxicant in porous matrix 102 or porous matrix 202).

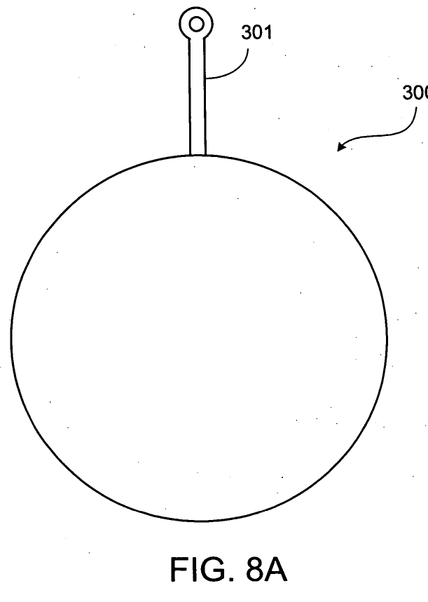

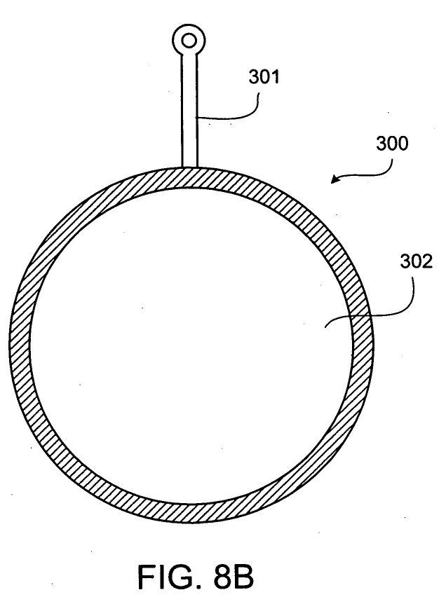

In some embodiments, a pest control system can include a porous matrix that is formed into the shape of a fruit or nut mimic. For example, FIGS. 8A and 8B show a generally spherical Suit or nut mimic 300 with a hanger 301 and a hollow center portion 302. Mimic 300 is formed of a feeding stimulant, a sustained release agent, a coloring agent, and a toxicant. Mimic 300 has a thickness “T” of from about 1 cm to about 5 cm (e.g., about 2 cm, about 2.5 cm). Hollow center portion has a diameter of from about 2 cm to about 7 cm (e.g., about 5 cm). Mimic 300 can be formed, for example, by injection molding. In some embodiments, mimic 300 can be formed by forming two separate hemispheres (e.g., by injection molding and/or by hydraulic pressure) and attaching the two hemispheres to each other (e.g., with an adhesive) to form the mimic.

Method of Making

A porous matrix 12 can be formed in the following way. Feeding stimulant and a dye or dye agent (such as food coloring) are dissolved in a solvent (such as water). In certain embodiments, one or more toxicants can also be added to the solvent. The mixture is then heated, and the molten mixture is poured off. While it is cooling, the mixture is agitated. The resultant granular mixture is later crushed to form a powder (and periodically stirred to prevent clumping). Thereafter, a sustained-release agent (such as wax) is melted and then folded into the mixture in a heated glass bowl. The mixture is then stirred until cool, and a small amount of dry mineral clay is added to the powdered mixture to prevent clumping (approximately 0.5%-1.0% by weight of the final mixture). In some embodiments, one or more toxicants can be added to the mixture as it is cooling and/or after it has been cooled. Using a hydraulic arbor press, the resulting coarse powder is then pressed by a piston head into a compression cylinder. The result is a cylindrical porous matrix with a concave base. The piston head can also be used to press reservoirs into the porous matrix. The final product is then ejected from the base of the compression cylinder.

If it is desired to add a mesh guard to the porous matrix, then prior to the use of the hydraulic arbor press, wire cloth is sleeved inside the compression cylinder. The powdered mixture is then placed into the compression cylinder and piston pressure is applied (as above). The wire mesh is thereby implanted into the outer layer of the finished cylindrical porous matrix. The final product is then ejected from the base of the compression cylinder.

A porous matrix 102 or 202 can be formed in the following way.

Feeding stimulant and dye or dye agent (such as food coloring) is dissolved in a solvent (such as water) to form a solution. In some embodiments, one or more toxicants can also be added to the solution. The mixture is then heated, and the molten mixture is poured off (e.g., onto a steel grid). While it is cooling, the mixture is stirred. The resulting mixture is then crushed (e.g., using a pestle) to a coarse powder. Wax (e.g., paraffin wax and/or carnauba wax) is then heated and melted (e.g., co-melted), and dye is added to the molten wax. The molten wax is then poured over the feeding stimulant mixture and stirred until cool. Toxicant is stirred into the cooled mixture, and the mixture (and, optionally, a rodent guard) are placed into a compression cylinder with a concave base. Using a hydraulic press, a piston head is pushed into the compression cylinder to form a dome-shaped porous matrix, which is then ejected from the concave base. One or more reservoirs can be added to the top of the porous matrix after ejection (e.g., by drilling). Alternatively or additionally, one or more reservoirs can be added to the top of the porous matrix during the compression process (e.g., using the piston head).

Method of Using

After the porous matrix is formed, it may be used in a pest control system. For example, if the targeted pests are apple maggot flies, then the porous matrix may be connected to an apple mimic (generally, a red imidacloprid-treated sphere), and the whole pest control system may be suspended in a tree in an orchard. Apple maggot flies, attracted to the apple mimic and its feeding stimulant, will land on the mimic, ingest some of the toxicant on the surface, and die shortly thereafter. Meanwhile, ambient moisture will collect in the reservoirs and leach through the porous matrix or run down the sides of the porous matrix, causing the porous matrix to release droplets, e.g., in a steady or substantially steady stream, of feeding stimulant onto the apple mimic. In this way, the apple mimic is continually refreshed with new feeding stimulant, so that it can continue to attract large numbers of apple maggot flies. If there is a dye within the porous matrix, then the dye will gradually leach out of the matrix as ambient moisture moves through the matrix's pores. Consequently, the color of the porous matrix will fade, which can be used as an indication to the user that it is time to replace the porous matrix.

### EXAMPLES

The following examples are intended as illustrative and non-limiting.

### Example 1A

A porous matrix was made in the following way:

20 ml water were brought to a boil, and 0.5 ml concentrated food coloring was added. 78.5 g sucrose were dissolved in the boiling mixture. The mixture was heated to 151° C. (without agitation) to reach the “hard crack” stage of molten sucrose.

The molten mixture was poured off and continuously agitated for 2 minutes to break up forming crystals. The resultant granular mixture was pestled to coarse powder and stirred periodically to prevent clumping.

10 g petroleum paraffin and 10 g carnauba wax were melted together and heated to 110° C.

20 g molten paraffin/carnauba wax-mixture were added to 80 g room temperature, powdered sucrose/dye/clay mixture in a heated (60° C.) glass bowl to prevent uneven cooling at the sides.

The molten wax mixture was folded into the powdered sucrose mixture and stirred until cool, resulting in a slightly malleable coarse powder at room temperature.

After cooling, 1.0 g mineral clay was stirred into the powdered mixture.

100 g of the final mixture were placed (at room temperature) into a 6.35 cm compression cylinder with a convex base plate. The mixture was molded by using a 20-ton hydraulic arbor press which pushed a machined piston head into the compression cylinder, thereby forming a cylindrical porous matrix with a concave base. Eight equal-sized, 2-mm deep, pie-shaped reservoirs were pressed into the porous matrix by the piston head.

The final product was ejected from the base of the compression cylinder.

### Example 1B

A porous matrix with an integrated rodent guard was made in the following way:

A coarse powder mixture was prepared as described in Example 1A. However, before the molding step occurred, a 3.0 cm by 20.0 cm collar of ⅛″ grid woven 27-gauge wire cloth was crimped to form a circle of diameter 6.35 cm. The circle was then sleeved inside the compression cylinder flush with the convex base.

100 g of the powder mixture were placed (at room temperature) into the compression cylinder. Upon application of piston pressure, the wire mesh was implanted into the outside layer of the finished cylindrical porous matrix, barring removal and subsequent damage to the finished product.

The final product was ejected from the base of the compression cylinder.

### Example 2

One hundred pest control systems were made in the following way:

Formation of Water-Soluble Feeding Stimulant:

Water-soluble feeding stimulant was prepared as follows:

1500 mL of water were brought to a boil.

22.5 mL of red food coloring was added to the water.

7200 grams of granulated sugar were dissolved in the water/food coloring solution, and the resulting solution was heated (without agitation) to 304° F. (151° C.), to reach the “hard crack” stage of molten sucrose.

The resultant mixture was poured onto a ⅛″ steel grid, and stirred as cooled to prevent clumping. The mixture was then pestled to a coarse powder.

Formation of Sustained-Release Agent:

Sustained-release agent was prepared as follows:

875 grams of paraffin wax and 875 grams of carnauba (Brazil) wax were co-melted and heated to 120° C.

45 mL of red liquid candlemaker's dye (from Lone Star Candle Co.) was added to the molten wax and stirred through.

The molten wax was poured over the cooled sugar mixture and stirred until cool.

Formation of Pest Control Systems:

Pest control systems were formed as follows:

11.25 grams of formulated Entrust (80% active spinosad) were stirred into the cooled granular mixture.

90 grams of the mixture (at room temperature) and a pre-formed wire mesh rodent guard were placed into a 7.5 cm compression cylinder with a concave base.

Using a 26-30 ton hydraulic press, a machined flat-faced piston head was pushed into the compression cylinder, forming a dome-shaped porous matrix embedded in the concave base plate.

The porous matrix was ejected from the concave base plate, and a reservoir was drilled into the top of the porous matrix.

A ⅛ hole was drilled through the center of the porous matrix to receive a hanging screw.

The porous matrix was mounted on a hollow, prefabricated flat-topped sphere to form the pest control system.

The pest control system formation process was repeated to form 100 pest control systems total. The porous matrices of the pest control systems had the following characteristics:

| Component | Percentage |
|---|---|
| Toxicant (Spinosad) | 0.10% |
| Inert | 0.025% |
| Sugar | 79.625% |
| Food Coloring agent (Red) | 0.25% |
| Paraffin Wax | 9.75% |
| Carnauba Wax | 9.75% |
| Candlemaker's Dye (Red) | 0.50% |

| Characteristic | Value | |
|---|---|---|
| Mass | 87 | grams |
| Volume | 68 | cm³ |
| Density | 1.28 | g/cm³ |
| Base Diameter | 7.5 | cm |
| Height | 2.0 | cm |
| Reservoir Capacity | 1.0 | mL |

Test Procedures

Simulated Rainfall Tests

For each of the simulated rainfall experiments, caps were mounted on 8.4 cm spheres prior to rain exposure. The spheres were painted gloss white to allow maximum visual interpretation of sucrose coverage and distribution.

A customized simulated rain chamber (with multiple-stage diffusers to simulate in-canopy rainfall exposure) was used. The rain chamber measured 60 cm (width)×60 cm (depth)×240 cm (height).

Five replicates of each tested treatment were exposed to 30 cm of artificially generated rainfall in 2.54 cm increments. In all trials of these caps, rain was applied at the rate of 2.54 cm per hour. To simulate the periodic rains of summer field conditions, no more than 1 hour of rainfall was applied per 24-hour period.

For each replicate of each treatment, all runoff water was collected in an individual catch basin. The runoff water was then tested for sucrose concentration using a Brix scale assessed with an Atago refractometer (0-32%, ±0.1%).

Apple Maggot Fly Bioassays—Laboratory Trials Without Toxicant

Candidate cap styles were mounted on 8.4 cm spheres and exposed to artificially generated rainfall (as above).

At 5 cm increments (i.e., once 5 cm of rain had fallen on the caps), spheres were removed from the chamber and allowed to dry. Fifty flies were introduced (individually) on spheres, and allowed to forage freely for a maximum of 600 seconds.

The total residence time and time spent feeding were recorded for each fly.

Apple Maggot Fly Bioassays—Laboratory Trials With Toxicant-Treated Spheres

Spheres (on which caps were mounted) were coated with black latex paint containing 4.0% (a.i.) imidacloprid, to kill flies alighting and feeding upon sphere surfaces.

The spheres were then placed in six commercial orchards in Massachusetts in a single quarter-acre plot in each orchard.

At the mid-point (6 weeks of field exposure) and end (12 weeks of field exposure) of the growing season, two spheres were returned to the laboratory. The fly-killing power of these field-exposed spheres was directly assessed by placing 20 flies (individually) on each sphere and allowing them to forage freely for a maximum of 600 seconds.

Residence time on the spheres was recorded for each fly, and the mortality rates of tested flies were assessed 24, 48, and 72 hours after testing.

Apple Maggot Fly Field Trials (Crop Protection)

For commercial-orchard evaluations of trap effectiveness, toxicant-treated spheres (as above) fitted with sucrose caps were placed in six commercial orchards in Massachusetts.

Traps were assessed by placing spheres in perimeter trees surrounding a small plot (˜49 trees per plot) in each orchard. Traps were placed 5 meters apart and baited with butyl hexanoate.

Treatment effectiveness was assessed by weekly comparisons of numbers of feral apple maggot flies captured on sticky unbaited monitoring traps on the interior of each plot and percent injury to fruit in samples taken every other week throughout the growing season.

In each orchard, performance of spheres with sucrose caps was compared with performance of sticky-coated spheres, biodegradable toxicant-treated spheres, and grower-applied whole-plot insecticide sprays.

Test Results

Samples Prepared

The following samples were prepared and used in testing:
A. Black or red wooden or plastic spheres with a diameter of 8.0-8.4 cm were treated with toxicant and fitted with one of the following:
   1. 3.8 cm diameter, 25 g cap formulated of molten sugar alone (78% sucrose, 22% fructose)
   2. 3.8 cm diameter, 25 g porous cap formulated of 85% sucrose and 15% paraffin, formed under 2 tons of hydraulic pressure
   3. 5.0 cm diameter, 50 g porous cap formulated with 85% sucrose and 15% paraffin, with 8 flutes shaped into the top surface of the cap to ensure shedding of rainfall, formed under 2 tons of hydraulic pressure
   4. 5.0 cm diameter, 50 g porous cap formulated with 85% sucrose and 15% paraffin with 8 shallow reservoirs pressed (under 2 tons of pressure) into the top surface of the cap to channel rainfall through the porous cap body
   5. 6.3 cm diameter, 100 g porous cap formulated with 80% sucrose and 20% paraffin with reservoirs as in (4), formed under 20 tons of hydraulic pressure
   6. 6.3 cm diameter, 150 g porous cap formulated with 80% sucrose and 20% paraffin formed under 20 tons of pressure, with reservoirs as in (4) and an integrated rodent guard
   7. 6.3 cm diameter, 150 g porous cap formulated with 79% sucrose, 10% paraffin, 10% carnauba wax, 1% mineral clay formed under 20 tons of pressure with reservoirs as in (4) and rodent guard as in (6)
B. Black or-red 7.7-8.4 cm-biodegradable (starch-based), toxicant-treated spheres.
C. Black or red wooden or plastic 8.0-8.4 cm spheres coated with a sticky substance (Tangletrap) to capture alighting flies.
D. Grower-applied, whole-plot treatment with phosmet or azinphosmethyl 2-3 times during the growing season.
   Comparative Test Results of Above Samples

Table 1—Cap A.3. vs. Cap A.4.—Sucrose Content in Runoff and on Sphere. Comparison of release of sucrose by two styles of wax/sugar caps (A.3. and A.4.).

TABLE 1

| | Sugar (grams) in | | Sugar (mg/cm²) retained | |
|---|---|---|---|---|
| | runoff water | | on sphere | |
| | Sphere Cap Style | | Sphere Cap Style | |
| Rainfall (inches) | A.3. | A.4. | A.3. | A.4. |
| 1 | 4.95 | 2.55 | 3.3 | 11.3 |
| 2 | 5.97 | 1.85 | 2.7 | 7.0 |
| 3 | 5.27 | 1.69 | 2.5 | 5.3 |
| 4 | 6.17 | 1.54 | 2.4 | 4.5 |
| 5 | 5.22 | 1.45 | 2.2 | 4.4 |
| 6 | 3.76 | 1.27 | 1.7 | 4.2 |
| 7 | 2.43 | 1.16 | 1.1 | 3.9 |
| 8 | 1.70 | 1.14 | 0.8 | 3.8 |
| Total (grams) | 35.47 | 12.65 | | |
| % Sugar Released | 83.5 | 29.8 | | |

The results in Table 1 show that a porous matrix that was associated with an A.4. sphere released less sucrose than did a porous matrix that was associated with an A.3. sphere. The porous matrix that was associated with an A.3. sphere had flutes, but no reservoirs. The porous matrix that was associated with an A.4. sphere had reservoirs, but no flutes.

Table 2—Capture of Flies and Fruit Injury for Different Caps. Captures of feral apple maggot flies on unbaited monitoring traps and percent injury to fruit by apple maggot in plots of apple trees in commercial orchards. In each case, the plot protection strategy listed represents the sole management tactic targeting apple maggot flies in each plot from early July through harvest.

TABLE 2

| | | Plot protection strategy (above) | | | |
|---|---|---|---|---|---|
| | | A.4. | B. | C. | D. |
| Year 1 | # AMF captured per plot* | 38 | 55 | 53 | 37 |
| | % fruit injury per plot** | 0.1 | 0.6 | 0.1 | 0.2 |
| | | A.4. | A.6. | C. | D. |
| Year 2 | # AMF captured per plot* | 53 | 57 | 53 | 53 |
| | % fruit injury per plot** | 0.38 | 0.13 | 0.17 | 0.13 |

*Mean captures per trap on 4 unbaited traps on the interior of each plot.
**Based on 100-200 fruit sampled per plot bi-weekly from July through September.

Table 2 shows the fly capture and fruit injury values associated with the A.4. and A.6. porous matrices, in comparison to other control strategies (B, C, and D).

Table 3—Mortality of Flies for Different Spheres/Caps. Mortality of apple maggot flies (AMF) after exposure to toxicant-treated spheres. All spheres were retrieved from commercial orchards at the mid-point (6 weeks field exposure) and end (12 weeks field exposure) of the field season. AMF were exposed (individually) to each treatment and allowed to forage freely for 10 minutes.

TABLE 3

| | AMF mortality (%) 72 hours after exposure to: | | | |
|---|---|---|---|---|
| | Spheres with | | Spheres without | |
| Duration of Field | Toxicant | | Toxicant | |
| Exposure | | Sugar | | Sugar |
| (Sphere Cap Style) | From Field* | Added** | From Field* | Added** |
| Year 1 (A.3.) | | | | |
| 6 weeks | 30.7 | 75.7 | 2.1 | 0.0 |
| 12 weeks | 41.4 | 75.0 | 0.0 | 3.0 |
| Year 2 (A.4.) | | | | |
| 6 weeks | 37.0 | 96.0 | 2.0 | 0.0 |
| 12 weeks | 39.0 | 100.0 | 3.0 | 0.0 |
| Year 3 (A.6.) | | | | |
| 6 weeks | 35.0 | 93.0 | 0.0 | 0.0 |
| 12 weeks | 29.0 | 95.0 | 0.0 | 0.0 |

*No additional treatment applied to spheres prior to testing.
**20% aqueous sucrose solution applied to spheres prior to testing.

The results in Table 3 show that toxicant-treated spheres associated with the A.4. and A.6. porous matrices exhibited higher fly mortality than did toxicant-treated spheres associated with the A.3. porous matrix (without a reservoir). Both the A.4. and the A.6. porous matrices had reservoirs, while the A.3. porous matrix had flutes, but no reservoirs. Additionally, the A.6. porous matrix had an integrated rodent guard and a higher paraffin content than the other two matrices.

Table 4—Release of Sucrose by Different Caps. Comparison of release of sucrose by three styles of wax/sugar caps (A.4., A.5., and A.6. (above)) under simulated rainfall.

TABLE 4

| | Sugar (grams) | | | Sugar (mg/cm²) | | |
|---|---|---|---|---|---|---|
| | in runoff water | | | retained on sphere | | |
| | Sphere Cap Style | | | Sphere Cap Style | | |
| Rainfall (Inches) | A.4. | A.5. | A.6. | A.4. | A.5. | A.6. |
| 1 | 7.04 | 9.26 | 8.86 | 16.3 | 21.4 | 20.5 |
| 2 | 8.45 | 7.65 | 6.04 | 19.5 | 17.7 | 13.9 |
| 3 | 5.39 | 4.83 | 4.63 | 12.5 | 11.1 | 10.7 |
| 4 | 4.63 | 5.23 | 8.45 | 10.7 | 12.1 | 19.5 |
| 5 | 2.82 | 3.22 | 5.63 | 6.5 | 7.4 | 13.0 |
| 6 | 2.62 | 1.81 | 3.42 | 6.1 | 4.2 | 7.9 |
| 7 | 1.61 | 1.81 | 5.84 | 3.7 | 4.2 | 13.5 |
| 8 | 1.81 | 1.61 | 7.24 | 4.2 | 3.7 | 16.7 |
| 9 | 1.61 | 1.81 | 3.02 | 3.7 | 4.2 | 7.0 |
| 10 | 1.20 | 1.41 | 3.22 | 2.8 | 3.3 | 7.4 |
| 11 | 0.80 | 0.80 | 2.01 | 1.8 | 1.8 | 4.6 |
| 12 | 0.80 | 1.00 | 1.81 | 1.8 | 2.3 | 4.2 |
| Total (grams) | 38.78 | 40.44 | 60.17 | | | |
| % Sugar | 96.9 | 50.6 | 50.1 | | | |
| Released | | | | | | |

The results in Table 4 show that over time, the porous matrices with a higher percentage of paraffin wax (i.e., the porous matrices associated with spheres A.5. and A.6.) released less sugar than the porus matrix with a lower percentage of paraffin wax (i.e., the porous matrix associated with sphere A.4.).

Table 5—Cap Damage by Rodents. Percentage of sphere caps receiving greater than 20% damage by nontarget (rodent) feeding, based on bi-weekly visual inspection of 180 caps of each type.

TABLE 5

| | Sphere caps | | |
|---|---|---|---|
| | damaged by | | |
| Duration of field | rodent feeding (%) | | |
| exposure (weeks) | A.3. | A.4.* | A.6. |
| 2 | 7.0 | 9.0 | 0.0 |
| 4 | 14.7 | 10.0 | 0.0 |
| 6 | 20.5 | 10.0 | 0.0 |
| 8 | 47.6 | 10.0 | 0.0 |
| 10 | 50.1 | 10.0 | 0.0 |
| 12 | 51.9 | 10.0 | 0.0 |

*For field comparison, an external wire rodent guard was added to cap style A.4.

The results in Table 5 show that an A.6. porous matrix, which had a rodent guard, was not damaged at all by rodents. By contrast, A.3. and A.4. porous matrices, which did not have rodent guards, were damaged by rodents. In the case of the A.3. porous matrix, rodent damage was substantial.

Table 6—Cap Resistance to Heat Degradation. Cap resistance to degradation under high heat conditions (50°-55° C.). Comparison of two cap styles (A.6 and A.7., above) and an intermediate (A.6.*). Caps exposed to high heat conditions daily for 30 days.

TABLE 6

| Sphere | | | | % Loss (mass) |
|---|---|---|---|---|
| Cap Style | % Paraffin | % Carnauba | % Sucrose | after exposure |
| A.6. | 20 | 0 | 80 | 74.0 |
| A.6.* | 15 | 5 | 80 | 41.0 |
| A.7. | 10 | 10 | 80 | 31.3 |

| Sphere | Loss to rainfall | Loss to heat | | Projected field |
|---|---|---|---|---|
| Cap Style | (grams) | (grams) | % Waste | life (weeks) |
| A.6. | 28.0 | 83.0 | 55.3 | 5.8 |
| A.6.* | 28.0 | 33.0 | 22.0 | 10.4 |
| A.7 | 28.0 | 19.0 | 12.7 | 13.7 |

*5% paraffin replaced with 5% carnauba wax as an intermediate step between cap styles A.6. and A.7.

The results in Table 6 show that porous matrices containing a mixture of paraffin and carnauba wax exhibited less degradation under high heat conditions and had a longer projected field life than a porous matrix containing just paraffin wax.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

What is claimed is:

1. A feeding stimulant release system, comprising:
a porous matrix comprising
a water-soluble or water-dispersible feeding stimulant,
an insoluble sustained-release agent, and
at least one reservoir located on an upper surface of the porous matrix,
wherein the feeding stimulant and the release agent comprise two homogenous phases dispersed in each other.

2. The feeding stimulant release system of claim 1, wherein the porous matrix further comprises a toxicant.

3. The feeding stimulant release system of claim 2, wherein the porous matrix is in the shape of a fruit or nut mimic.

4. The feeding stimulant release system of claim 2, wherein the porous matrix is in the shape of a sphere.

5. The feeding stimulant release system of claim 4, wherein the sphere is hollow.

6. The feeding stimulant release system of claim 1, wherein the depth of the reservoir is less than about eight millimeters.

7. The feeding stimulant release system of claim 1, wherein the porous matrix comprises between about six and about ten reservoirs.

8. The feeding stimulant release system of claim 1, wherein the porous matrix comprises one reservoir.

9. The feeding stimulant release system of claim 1, wherein the feeding stimulant comprises sucrose.

10. The feeding stimulant release system of claim 1, wherein the sustained-release agent comprises wax.

11. The feeding stimulant release system of claim 10, wherein the wax comprises carnauba wax, paraffin wax, or a combination thereof.

12. The feeding stimulant release system of claim 11, wherein the sustained-release agent comprises between about 60% and about 90% paraffin wax.

13. The feeding stimulant release system of claim 12, wherein the sustained-release agent comprises about 80% paraffin wax.

14. The feeding stimulant release system of claim 11, wherein the sustained-release agent comprises between about 10% and about 40% carnauba wax.

15. The feeding stimulant release system of claim 14, wherein the sustained-release agent comprises about 20% carnauba wax.

16. The feeding stimulant release system of claim 1, further comprising a mesh layer disposed around the porous matrix.

17. The feeding stimulant release system of claim 16, wherein the mesh layer comprises wire cloth.

18. The feeding stimulant release system of claim 1, wherein the porous matrix further comprises a coloring agent.

19. The feeding stimulant release system of claim 1, further comprising a toxicant.

20. The feeding stimulant release system of claim 1, wherein the porous matrix is hemispherical.

21. The feeding stimulant release system of claim 1, wherein the porous matrix is cylindrical.

22. A pest control system, comprising:
a fruit or nut mimic including a toxicant; and
a porous matrix of claim 1.

23. The pest control system of claim 22, wherein the toxicant comprises imidacloprid.

24. The pest control system of claim 22, wherein the toxicant comprises spinosad.

25. The pest control system of claim 22, wherein the porous matrix further comprises a toxicant.

26. The pest control system of claim 25, wherein the toxicant in the porous matrix is the same as the toxicant in the fruit or nut mimic.

27. The pest control system of claim 25, wherein the toxicant in the porous matrix is different from the toxicant in the fruit or nut mimic.

28. A method of making a porous matrix for use in a feeding stimulant release system, the method comprising:
(a) combining a water-soluble or water-dispersible feeding stimulant with an insoluble sustained-release agent;
(b) forming the combination into a porous matrix, wherein the feeding stimulant and the release agent comprise two homogenous phases dispersed in each other; and
(c) forming at least one reservoir in the porous matrix.

29. The method of claim 1, further comprising adding a toxicant to the combination.

30. A method of pest control, the method comprising:
(a) obtaining a pest control system of claim 22;
(b) disposing the porous matrix of the system above the fruit or nut mimic; and
(c) placing the system in an area containing pests.

31. A pest control system, comprising:
a fruit or nut mimic comprising a porous matrix of claim 1.

32. The pest control system of claim 31, wherein the porous matrix is hemispherical.

33. The pest control system of claim 32, further comprising a bottom portion that is attached to the porous matrix.

34. The pest control system of claim 33, wherein the bottom portion is hemispherical.

35. The pest control system of claim 33, wherein the bottom portion comprises a plastic, a wood, or a metal.
